(19) United States
(12) Patent Application Publication
(10) Pub. No.: US 2026/0358985 A1
(43) Pub. Date: Nov. 12, 2026

(54) STORAGE MEDIUM, INFORMATION PROCESSING APPARATUS, AND CONTROL METHOD

(71) Applicant: CANON KABUSHIKI KAISHA, Tokyo (JP)

(72) Inventor: TAKAHIRO SAKAMOTO, Kanagawa (JP)

(21) Appl. No.: 19/667,908

(22) Filed: May 5, 2026

(30) Foreign Application Priority Data
May 7, 2025 (JP) 2025-077318

(51) Int. Cl. G06F 3/12

(52) U.S. Cl. CPC G06F 3/1204; G06F 3/1206; G06F 3/1208; G06F 3/1256; G06F 3/1287; G06F 3/1288

(57) ABSTRACT

User operations can be simplified. A program causes a computer to function as the following units: a read control unit configured to perform control to read a file saved in a file format supported by a web application operating in an external device; an upload control unit configured to perform control to upload, based on information included in the read file, the read file to the external device; and a browser control unit configured to perform control to display, on a web browser, a screen for the web application where the file uploaded to the external device has been read.

### BACKGROUND

### Field of the Technology

The present disclosure relates to a storage medium, an information processing apparatus, and a control method.

### Description of the Related Art

In recent years, web printing systems have been provided where various kinds of printed matter can be created and printed using a web server as well as a computer and a printer that are placed at home or in an office. In such a web printing system, a print job generated on a web server can be downloaded to a terminal apparatus through a printing application program operating on the terminal apparatus. Also, in the web printing system, the downloaded print job can be transmitted from the terminal apparatus to the printer through a printer driver and printed.

A web application used in such a web printing system can create print content such as a poster and save the created print content to the terminal apparatus or to a cloud. For example, in a case where the print content is saved in the file format of Portable Document Format (PDF), the file can be associated with Adobe Acrobat Reader (registered trademark) in the terminal apparatus. In this case, the user can open the PDF file by double-clicking on the PDF file.

However, in a case where the file outputted from the web application is in a non-standard file format and includes layout information that is re-editable on the web application, the file is associated with none of the applications installed in the terminal apparatus. Thus, in the event of re-editing the layout information saved by the web application, the web application cannot be activated directly from the file including the layout information. In this case, the user needs to perform a number of operations, including an operation of reading the file into the web server, an operation of activating a web browser, and an operation of accessing a web application operating on the web server. Thus, the operations are complicated.

Published Japanese Patent Laid-Open No. 2016-513827 discloses a technique for obtaining a web resource identifier used to access a web application corresponding to a third-party native application by inquiring of a search server.

### SUMMARY

What is desired is to simplify user operations.

An aspect of the present disclosure is a program that causes a computer to function as the following units: a read control unit configured to perform control to read a file saved in a file format supported by a web application operating in an external device; an upload control unit configured to perform control to upload, based on information included in the read file, the read file to the external device; and a browser control unit configured to perform control to display, on a web browser, a screen for the web application where the file uploaded to the external device has been read.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram showing an example configuration of a printing processing system according to the present embodiment;

FIG. 2 is a block diagram showing an example hardware configuration of a terminal apparatus;

FIG. 3 is a block diagram showing an example hardware configuration of a printing apparatus;

FIG. 4 is a block diagram showing an example hardware configuration of a web server;

FIG. 5 is a block diagram showing an example software configuration of the web server;

FIGS. 6A and 6B are each a block diagram showing an example software configuration of the terminal apparatus;

FIG. 7 is a diagram showing an example of an image creation screen;

FIG. 8 is a diagram showing an example of a printing screen;

FIG. 9 is a flowchart showing an example flow of processing by a printing application executed in a first embodiment;

FIG. 10 is a flowchart showing an example flow of processing by the printing application executed in a second embodiment;

FIG. 11 is a diagram showing an example of a dialogue box;

FIG. 12 is a diagram showing an example screen for a native application; and

FIG. 13 is a flowchart showing an example flow of processing by the printing application executed in a third embodiment.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. Incidentally, an identical reference numeral is assigned to an identical constituent and an explanation thereof is made.

### First Embodiment

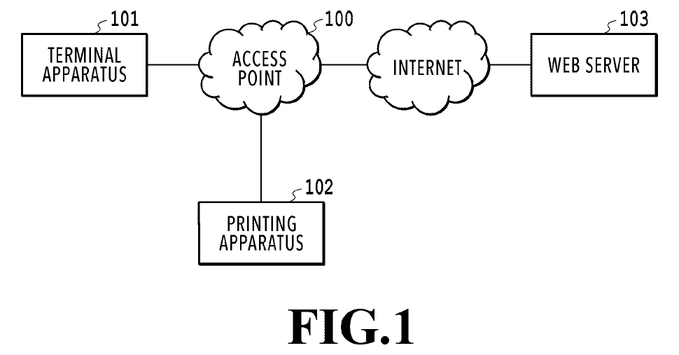

FIG. 1 is a diagram showing an example configuration of a printing processing system according to the present embodiment. The printing processing system includes a terminal apparatus 101, a printing apparatus 102, and a web server 103. Using a printing application, a user can print data created on a web application provided by the web server 103.

The terminal apparatus 101 is an information processing apparatus capable of processing various kinds of information. Examples of the terminal apparatus 101 include a smartphone, a personal computer, a tablet terminal, a mobile phone, and a personal digital assistant (PDA).

The printing apparatus 102 is a printer that forms (prints) an image on a printing medium such as paper by applying a printing agent such as ink to the printing medium. Although the printing apparatus 102 in the present embodiment is an apparatus that performs inkjet printing, the present disclosure is not limited to this. For example, the printing apparatus 102 may be an apparatus that performs printing using electrophotography or the sublimation method. Also, the printing apparatus 102 may be a multifunction machine including a plurality of functions such as a copy function, a facsimile function, and a print function.

In the printing processing system, the terminal apparatus 101 may communicate with the printing apparatus 102 via a network. Also, in the printing processing system, the terminal apparatus 101 may communicate with the web server 103. Although the network via which the terminal apparatus 101 communicates with the web server 103 is the Internet in the example in FIG. 1, the present disclosure is not limited to this. Also, although the network via which the terminal apparatus 101 communicates with the printing apparatus 102 is a local area network (LAN) here, the present disclosure is not limited to this. For example, the network used by the terminal apparatus 101 to communicate with the web server 103 may be the same as the network used by the terminal apparatus 101 to communicate with the printing apparatus 102. Note that the network may be wireless, wired, or a combination of wireless and wired.

The terminal apparatus 101 may connect to the network through one or more access points 100. Programs such as a printing application are stored in the terminal apparatus 101. Print data created using the printing application is transmitted from the terminal apparatus 101 to the printing apparatus 102 via the network.

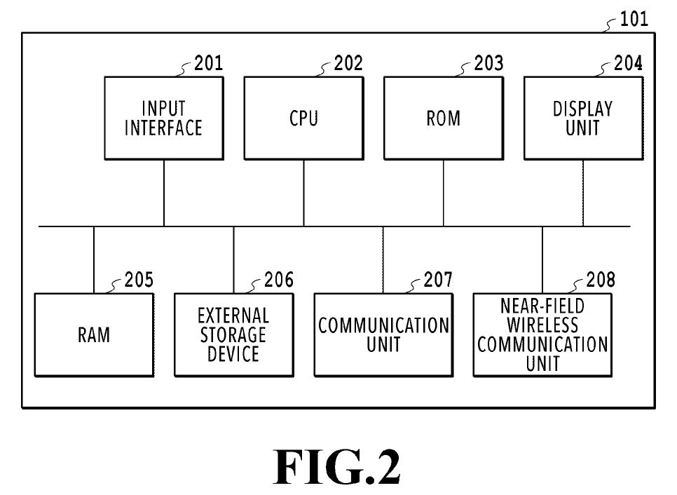

FIG. 2 is a block diagram showing an example hardware configuration of the terminal apparatus 101. The terminal apparatus 101 has a plurality of functional blocks connected to one another through an internal bus. The functional blocks that the terminal apparatus 101 has include an input interface 201, a central processing unit (CPU) 202, read-only memory (ROM) 203, a display unit 204, random-access memory (RAM) 205, an external storage device 206, a communication unit 207, and a near-field wireless communication unit 208.

Note that at least some of the input interface 201, the CPU 202, the ROM 203, the display unit 204, the RAM 205, the external storage device 206, the communication unit 207, and the near-field wireless communication unit 208 may be configured as one functional block. Alternatively, at least one of the input interface 201, the CPU 202, the ROM 203, the display unit 204, the RAM 205, the external storage device 206, the communication unit 207, and the near-field wireless communication unit 208 may be divided into two or more functional blocks. This applies to the functional blocks to be described later as well.

The input interface 201 receives input of various kinds of information. The input interface 201 may include an input device capable of receiving an input based on a user operation.

The CPU 202 is a processor that performs control for implementing the various functions of the terminal apparatus 101. The CPU 202 performs various kinds of control by program execution or hardware activation. The CPU 202 may perform processing in cooperation with a graphics processing unit (GPU) (not shown).

The ROM 203 stores various kinds of data. Data stored in the ROM 203 include fixed data such as control programs executed by the CPU 202, data tables, and OS programs. The data stored in the ROM 203 includes the printing application for creating print data.

The display unit 204 displays various kinds of information. Information displayed by the display unit 204 includes a user interface (UI) screen. The display unit 204 may be configured of a light-emitting diode (LED), a liquid crystal display (LCD), or the like. The display unit 204 is an interface for receiving data input and an operation instruction from the user and may be a physical keyboard, buttons, or an operation panel configured of a touch panel or the like.

The RAM 205 is configured of, e.g., static RAM (SRAM) that requires a backup power source. Because the RAM 205 retains data using power from a primary battery for data backup (not shown), the RAM 205 can store data such as program control variables without volatilizing them. The RAM 205 is also provided with a memory area for storing configuration information, management data, and the like on the terminal apparatus 101. Also, the RAM 205 is used as the main memory and work memory for the CPU 202 as well.

The external storage device 206 may be configured of a mass storage device such as a hard disk drive. The communication unit 207 includes a circuit and an antenna for performing communications using a predetermined wireless communication method. The communication unit 207 can wirelessly connect to the access point 100. Also, the communication unit 207 may operate as a temporarily used access point. Wireless communication used in the present embodiment may be communication operated according to a wireless LAN wireless communication method (Wi-Fi) conforming to the IEEE 802.11 standard series or communication operated according to other wireless communication methods.

The near-field wireless communication unit 208 executes near-field wireless communications with other devices present within a certain close range from the terminal apparatus 101. The near-field wireless communication unit 208 performs communication using a wireless communication method different from that used by the communication unit 207. Examples of the communication method include near-field communication (NFC), Bluetooth (registered trademark) Classic, Bluetooth Low Energy (BLE), and Wi-Fi Aware.

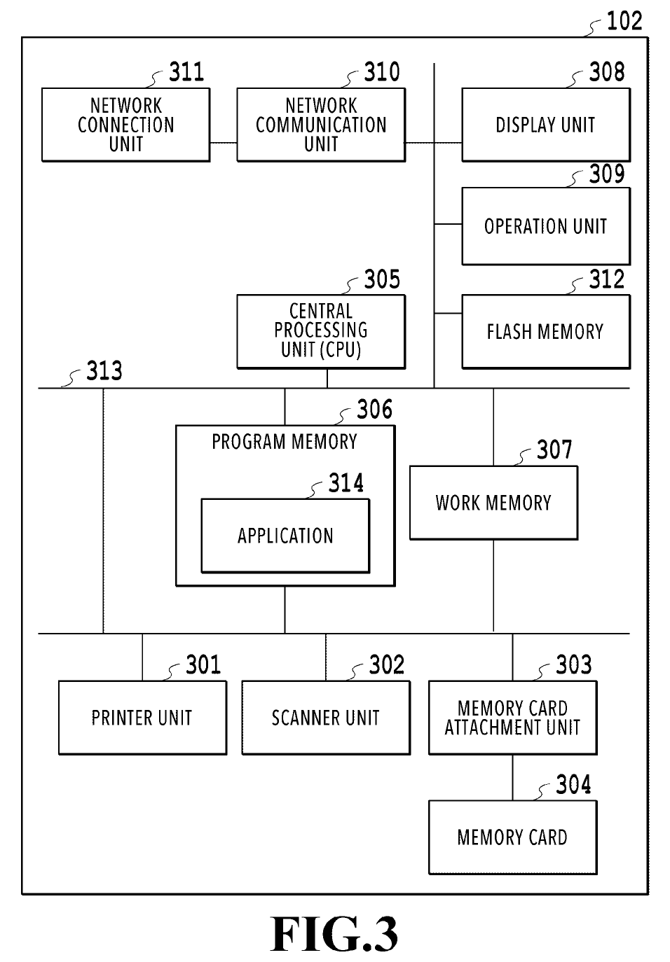

FIG. 3 is a block diagram showing an example hardware configuration of the printing apparatus 102. The printing apparatus 102 has a plurality of functional blocks. The functional blocks that the printing apparatus 102 has include a printer unit 301, a scanner unit 302, a memory card attachment unit 303, and a memory card 304.

The printing apparatus 102 has a print function, a scanner function, a copy function, and a storage function. The print function is implemented by the printer unit 301. The printer unit 301 executes printing based on image data received from the outside or image data stored in the memory card 304. Also, the printer unit 301 manages consumable information such as ink and paper levels.

The scanner function is implemented by the scanner unit 302. The scanner unit 302 is a functional block that implements the scanner function. The scanner unit 302 optically reads an original set on an original bed (not shown) and converts the original into electronic data. The converted electronic data is image data in a specified file format. The image data is either transmitted to an external device via the network or stored in a storage region (not shown).

The copy function is implemented by the printer unit 301 and the scanner unit 302. Specifically, the scanner unit 302 generates image data, the generated image data is transferred to the printer unit 301, and the printer unit 301 performs printing based on the image data transferred thereto.

The storage function is implemented by the memory card attachment unit 303 and the memory card 304. Specifically, in a case where file data is stored in the memory card 304 attached to the memory card attachment unit 303, the file data is sent to an editing apparatus (not shown) via the network and is edited on the editing apparatus. The edited file data may be stored in the memory card 304.

The functional blocks that the printing apparatus 102 has further include a CPU 305, program memory 306, work memory 307, a display unit 308, an operation unit 309, a network communication unit 310, a network connection unit 311, and flash memory 312. The functional blocks that the printing apparatus 102 has are connected to one another by a bus 313.

The CPU 305 is a processor that performs control for implementing the various functions of the printing apparatus 102. The CPU 305 performs various kinds of control by program execution or hardware activation. The CPU 305 may perform processing in cooperation with a GPU (not shown).

The program memory 306 stores various kinds of data. The program memory 306 may be formed of ROM. The data stored in the program memory 306 incudes various program codes and an application 314. For example, the application 314 can obtain consumable information by accessing the printer unit 301 and transmits consumable levels to the web server 103 at predetermined timing.

In execution of any of the functions, the work memory 307 is used as a temporary storage region in a case where, e.g., buffering is to be executed. The work memory 307 may be formed of RAM.

The display unit 308 displays various kinds of information. The information displayed by the display unit 308 includes a UI screen. The display unit 308 may be formed of an LED, an LCD, or the like.

The operation unit 309 can receive an input based on a user operation performed on the operation unit 309. The operation unit 309 includes a switch or the like for a user to perform various input operations. The switch may be a physical switch or a virtual switch.

The network communication unit 310 connects to a network such as the Internet through the network connection unit 311 and communicates with the outside. For example, the network communication unit 310 communicates with the outside through a wired LAN or a wireless LAN. In a case where the network communication unit 310 supports wired LAN, the network connection unit 311 is, for example, a connector for connecting a wired LAN cable. In a case where the network communication unit 310 supports wireless LAN, the network connection unit 311 is, for example, an antenna. Note that the network connection unit 311 may support both of wired LAN and wireless LAN. In the present embodiment, the network communication unit 310 supports wireless LAN and connects to the access point according to a wireless LAN wireless communication method conforming to the IEEE 802.11 standard series.

The flash memory 312 is non-volatile memory for storing, e.g., image data received by the network communication unit 310.

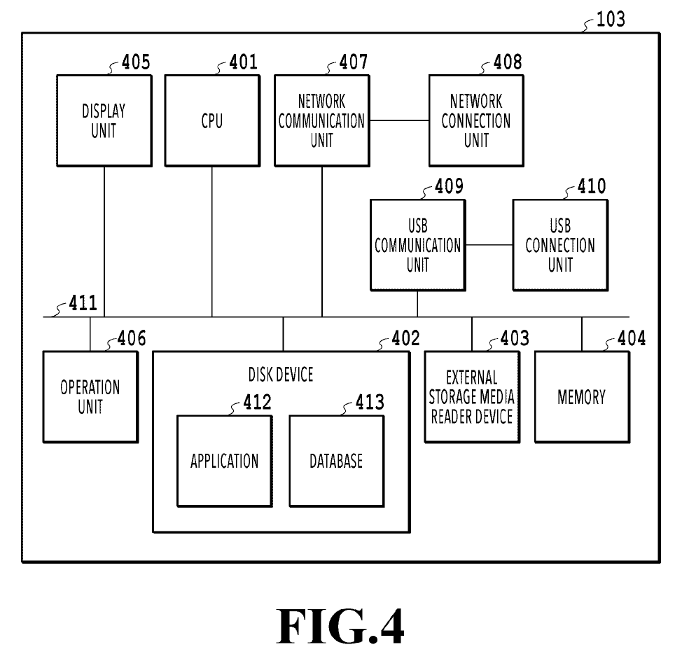

FIG. 4 is a block diagram showing an example hardware configuration of the web server 103. The web server 103 has a plurality of functional blocks. The functional blocks that the web server 103 has include a CPU 401, a disk device 402, an external storage media reader device 403, memory 404, and a display unit 405. The functional blocks that the web server 103 has also include an operation unit 406, a network communication unit 407, a network connection unit 408, a Universal Serial Bus (USB) communication unit 409, and a USB connection unit 410. These functional units are connected to one another by a bus 411.

The CPU 401 is a processor that performs control for implementing various functions of the web server 103. The CPU 401 performs various kinds of control by program execution or hardware activation. The CPU 401 may perform processing in cooperation with a GPU (not shown).

The disk device 402 stores various kinds of data. The data stored in the disk device 402 include an application 412, a database 413, an OS, various files, and the like.

The external storage media reader device 403 is a device for reading information such as a file stored in an external storage medium such as a Secure Digital (SD) card. In a case where the CPU 401 performs control, the memory 404 is used as a temporary storage region for data in a case where, e.g., buffering is to be executed.

The display unit 405 displays various kinds of information. The information displayed by the display unit 405 includes a UI screen. The display unit 405 may be formed of an LED, an LCD, or the like.

The operation unit 406 can receive an input based on a user operation performed on the operation unit 309. The operation unit 406 includes a keyboard, a mouse, and the like.

The network communication unit 407 connects to a network such as the Internet through the network connection unit 408 and communicates with the outside. For example, the network communication unit 407 communicates with the outside through a wired LAN or a wireless LAN. In a case where the network communication unit 407 supports wired LAN, the network connection unit 408 is, for example, a connector for connecting a wired LAN cable. In a case where the network communication unit 407 supports wireless LAN, the network connection unit 408 is, for example, an antenna. Note that the network connection unit 408 may support both of wired LAN and wireless LAN.

The USB communication unit 409 communicates with various peripherals through the USB connection unit 410. This communication is performed according to the USB standards.

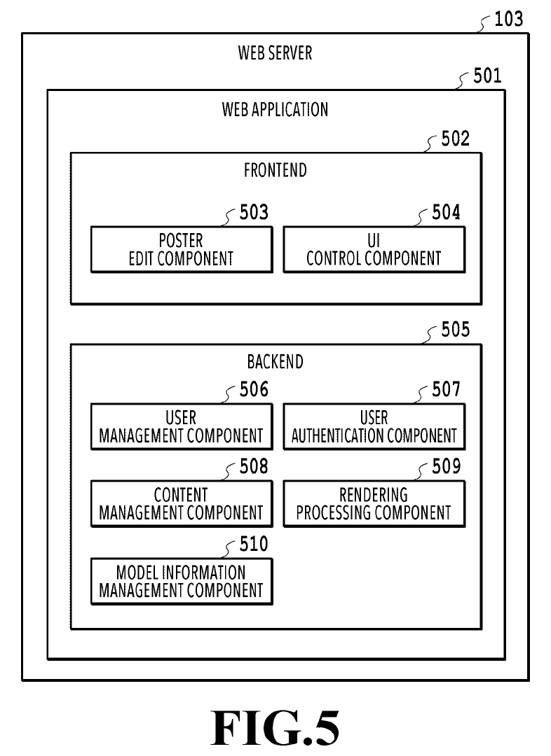

FIG. 5 is a block diagram showing an example software configuration of the web server 103. The web server 103 has a web application 501. The web application 501 includes application programs constituting the web application 501.

The web application 501 includes a frontend 502. The frontend 502 mainly performs control of a web browser. The frontend 502 has a poster edit component 503 and a UI control component 504.

The poster edit component 503 functions as an edit component that performs image editing processing. This image includes a poster image. The UI control component 504 functions as a user interface that displays an operation object and the like on the web browser and receives a user operation performed on the operation object.

The web application 501 includes a backend 505. The backend 505 performs various kinds of processing in response to a request from the frontend 502. The backend 505 has a user management component 506, a user authentication component 507, a content management component 508, a rendering processing component 509, and a model information management component 510.

The user management component 506 functions as a management component that manages user information identifying a user. For example, the user management component 506 manages user information included in cookies. The user authentication component 507 functions as an authentication component that issues a unique identifier for each user in association with their user information and performs authentication based on the identifier. The content management component 508 functions as a management component that manages content such as image data created. The rendering processing component 509 functions as a processing component that performs rendering processing on content managed by the content management component 508. The model information management component 510 functions as a management component that manages model information including, e.g., model information on the printing apparatus 102.

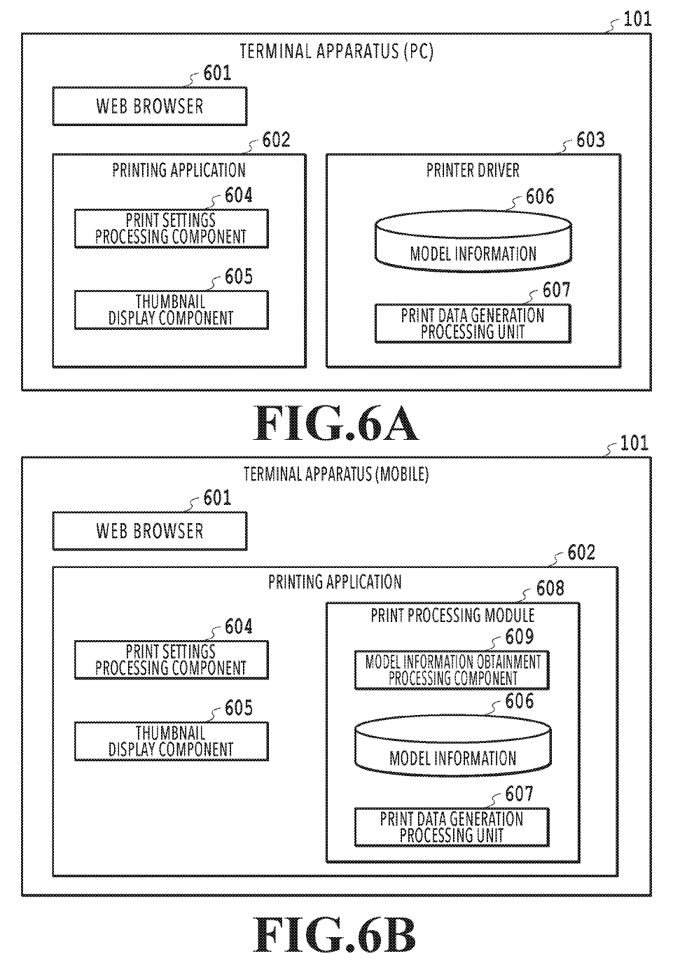

FIG. 6A is a block diagram showing an example software configuration of the terminal apparatus 101 in a case where the terminal apparatus 101 is a personal computer. The terminal apparatus 101 has a web browser 601, a printing application 602, and a printer driver 603.

The web browser 601 is software for viewing web pages and the like. For example, "Microsoft Edge," "Google Chrome (registered trademark)," "Firefox (registered trademark)," "Safari (registered trademark)," or the like may be used as the web browser 601.

The printing application 602 includes application programs constituting the printing application 602. The printing application 602 is an application for performing printing based on print settings configured by a user. In the present embodiment, the printing application 602 is a native application supporting the format of files created by the web application 501. Thus, the printing application 602 can cause the printing apparatus to print content data created on the web application 501.

The printing application 602 has a print settings processing component 604 and a thumbnail display component 605. The print settings processing component 604 functions as a processing component for configuring print settings. The thumbnail display component 605 functions as a display component that displays a thumbnail based on image data including an image created by a user. The thumbnail display component 605 generates a thumbnail image for preview presentation by reducing the image created by the user and displays the thumbnail image thus generated. The image data may include data including a poster image (poster data).

The printer driver 603 is a driver that performs processing for generation of print data that can be printed by the printer. The printer driver 603 is distributed by the vendor of the printer, installed by a user, and used. Also, the printer driver 603 may be packaged with the OS. The printer driver 603 has a printer model information 606 and a print data generation processing unit 607. The model information 606 has settings information that can be configured at the time of printing and the like and stored for each printer. The model information 606 includes, e.g., settings information on the printing apparatus 102. Examples of the settings information include a setting value for the paper feed method and the sheet type. The print data generation processing unit 607 functions as a processing unit that performs processing to generate print data.

FIG. 6B is a block diagram showing an example software configuration of the terminal apparatus 101 in a case where the terminal apparatus 101 is a mobile terminal. In a case where the terminal apparatus 101 is a mobile terminal, the terminal apparatus 101 does not have the printer driver 603. Thus, the printing application 602 has a printing processing module 608 in addition to the print settings processing component 604 and the thumbnail display component 605.

The printing processing module 608 has a model information obtainment processing component 609 in addition to the printer model information 606 and the print data generation processing unit 607 described above. The model information obtainment processing component 609 functions as a processing component that obtains the model information 606 from the printing apparatus 102 through a network. Note that the model information 606 obtained is stored in, for example, the external storage device 206.

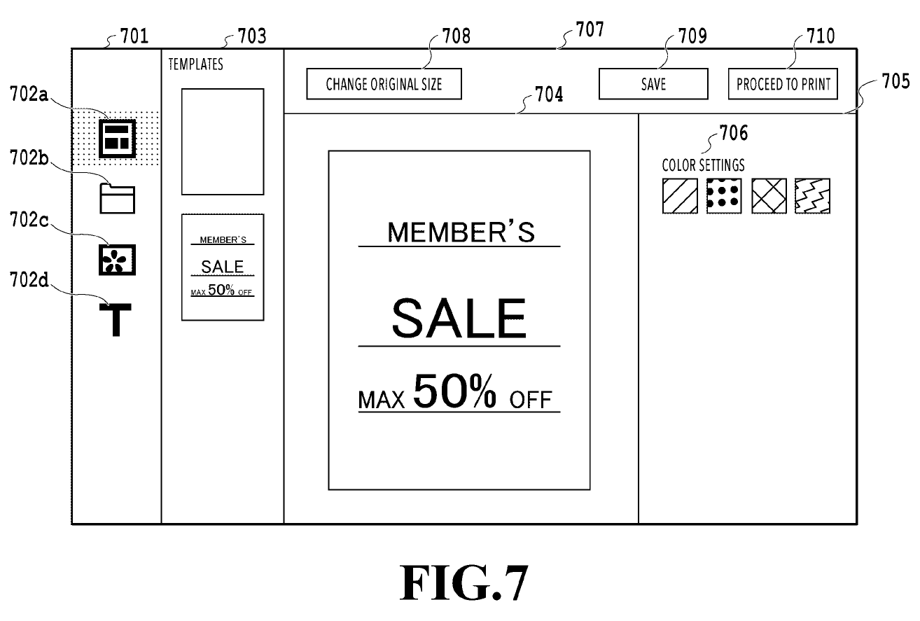

FIG. 7 is a diagram showing an example of an image creation screen. The image creation screen shown in FIG. 7 is a screen for the web application 501. The image creation screen shown in FIG. 7 is displayed on the browser screen of the web browser 601 in the terminal apparatus 101 as controlled by the UI control component 504 of the frontend 502. In the example in FIG. 7, a poster image may be created and printed.

The image creation screen shown in FIG. 7 is provided with a region 701 where a menu is displayed. The menu displayed in the region 701 includes a template icon 702a, a file read icon 702b, a clip art icon 702c, and a text insert icon 702d.

The image creation screen shown in FIG. 7 is provided with a region 703 and an edit area 704. The region 703 displays a list of contents associated with the icon selected in the region 701 and displays a list of poster image templates in the example in FIG. 7. The list of templates is displayed in a case where the template icon 702a is selected on the region 701. Once a user selects a desired template, the selected template is displayed in the edit area 704.

A user can create a poster image by editing the template displayed in the edit area 704. For example, in a case where the clip art icon 702c is selected in the region 701 with a template displayed in the edit area 704, a list of clip arts is displayed in the region 703. Once the user selects a desired clip art, the selected clip art is placed on the template displayed in the edit area 704.

The image creation screen shown in FIG. 7 is provided with a region 705 displaying a menu of operations that may be applied to an object placed on the template. In the example in FIG. 7, a list of color settings 706 for the clip art object placed on the template is displayed. The list of color settings 706 is displayed in a case where an object placed on the template is selected. Once the user selects a desired color, the color selected is applied to the object.

The image creation screen shown in FIG. 7 is provided with a region 707 displaying a menu of edits that may be performed with respect to the image displayed in the edit area 704. The menu of edits displayed in the region 707 include a Change Original Size button 708, a Save button 709, and a Print button 710. The Change Original Size button 708 is a button for changing the size of the original for the poster image. The Save button 709 is a button for saving the image displayed in the edit area 704 to the ROM 203 of the terminal apparatus 101 or to a cloud storage as a poster image. The Print button 710 is a button for printing the image displayed in the edit area 704 as a poster image. In a case where the user presses the Print button 710, the backend 505 generates a print job, and the printing application 602 is activated.

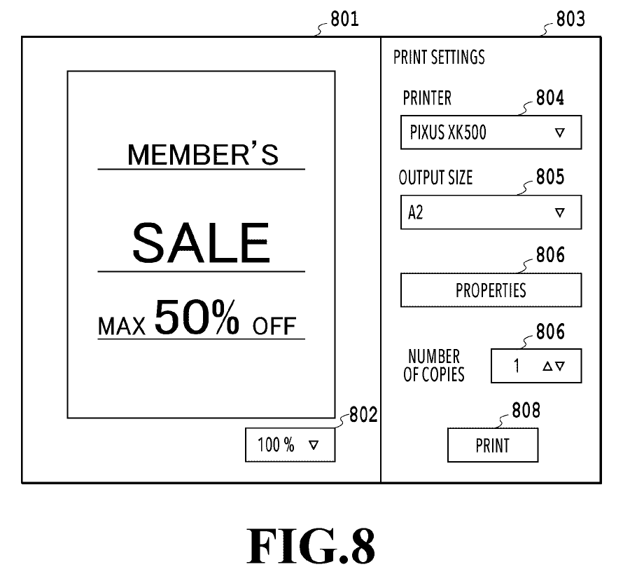

FIG. 8 is a diagram showing an example of a printing screen. The printing screen shown in FIG. 8 is a screen for the printing application 602. The printing screen shown in FIG. 8 is displayed on the display unit 204 of the terminal apparatus 101 upon pressing of the Print button 710 on the image creation screen shown in FIG. 7.

The printing screen shown in FIG. 8 is provided with a preview region 801 and a scale up/down button 802. The preview region 801 is a region displaying poster data created on the web application 501. The scale up/down button 802 is a button for switching the display magnification of the image displayed in the preview region 801. The user can switch the display magnification of the image (poster image) displayed in the preview region 801 by selecting a magnification ratio from the menu displayed upon pressing of the scale up/down button 802.

The printing screen shown in FIG. 8 is provided with a print settings region 803. The print settings region 803 is a region for configuring print-related settings and the like. In the example in FIG. 8, the print settings region 803 is provided with a printer button 804, an output size button 805, a properties button 806, a number of copies button 807, and a Print button 808. A user can select a printer model to be used to print the poster from the menu displayed upon pressing of the printer button 804. The user can also select the size of the sheet used to output the poster from the menu displayed upon pressing of the output size button 805. The user can also configure detailed print settings, such as double-sided printing and margins, from a settings screen for the printer driver activated upon pressing of the properties button 806. The user can also specify the number of print copies of the image (poster image) displayed in the preview region 801 by pressing the number of copies button 807. By pressing the Print button 808, the user can also cause the printer to start printing.

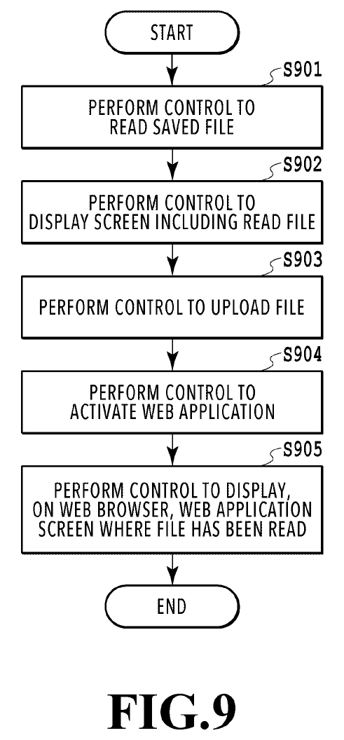

FIG. 9 is a flowchart showing an example flow of processing by the printing application 602 executed in the first embodiment. The letter "S" used in the following description of the flowchart denotes "Step." Note that processing performed in some or all of the steps shown in the flowchart below may be implemented by hardware such as an application-specific integrated circuit (ASIC) or an electronic circuit.

A file is saved to the terminal apparatus 101 by pressing of the Save button 709 on the image creation screen shown in FIG. 7. The file saved to the terminal apparatus 101 is in the file format supported by the web application 501. The file saved to the terminal apparatus 101 includes layout information. The extension of the file saved to the terminal apparatus 101 is associated with the printing application 602 by the OS of the terminal apparatus 101.

Once the user performs an operation, such as double-clicking, on the file saved in the terminal apparatus 101, the OS receives an instruction to activate the printing application 602 associated with the extension of the file. Upon receipt of the instruction to activate the printing application 602, an application program of the printing application 602 is read into the RAM 205 by the OS. The CPU 202 executes the application program of the printing application 602 read into the RAM 205, and the printing application 602 then starts a series of processes in the flowchart shown in FIG. 9.

In S901, the printing application 602 performs control to read the file saved in the terminal apparatus 101. Specifically, the printing application 602 requests the OS that the file a read instruction for which has been received be read into the RAM 205 and thereby causes the OS to read the file. Once the file is read, the processing proceeds to S902.

In S902, the printing application 602 performs control to display a screen including the content of the file read in S901 on the display unit 204 of the terminal apparatus 101. In the present embodiment, the printing application 602 controls display of a preview screen including layout information. Specifically, the printing application 602 requests the CPU 202 to display the printing screen shown in FIG. 8 on the display unit 204 of the terminal apparatus 101 and display layout information in the preview region 801 of that printing screen and thereby causes the CPU 202 to display the screen. Once the screen including the content of the file read in S901 is displayed, the processing proceeds to S903.

In S903, the printing application 602 performs control to upload the file to the web server 103. Specifically, through the OS, the printing application 602 requests the CPU 202 to upload the file to the web server 103. The CPU 202 accesses the web server 103 through the network and transmits the file to the web server 103. Specifically, the printing application 602 calls an application programming interface (API) of the web application 501 and obtains an URL to which to upload the file. The printing application 602 uploads the file to the web server 103 using the URL. Once the file is uploaded, the processing proceeds to S904.

In S904, the printing application 602 performs control to activate the web browser 601. Specifically, through the OS, the printing application 602 requests the CPU 202 to activate the web browser 601. The CPU 202 loads a program of the web browser 601 into the RAM 205, executes the program, and activates the web browser 601. Once the web browser 601 is activated, the processing proceeds to S905.

In S905, the printing application 602 performs control to display, on the web browser 601 activated in S903, a screen for the web application 501 where the file uploaded to the web server 103 in S903 has been read. Specifically, the printing application 602 calls the API of the web application 501 and requests the web application 501 to process the file. As a result of the processing of the file, the web application 501 supplies the printing application 602 with data including the layout information included in the file and screen information for the web application 501. The printing application 602 requests the CPU 202 to display the layout information and the screen for the web application 501 on the web browser 601 and thereby causes the CPU 202 to display the screen. As a result, the image creation screen shown in FIG. 7 is displayed, and layout information is displayed in the edit area 704 of the image creation screen.

As described above, according to the present embodiment, user operations can be simplified. For example, the printing application 602 as a read control unit performs control to read a file saved in a file format supported by the web application 501 operating on the web server 103, which is an external device. The printing application 602 as an upload control unit performs control to upload the read file to the web server 103. The printing application 602 as a browser control unit performs control to display, on the web browser 601, a screen for the web application 501 where the uploaded file has been read. This eliminates the need for the user to perform, e.g., an operation for reading the file to the web server 103, an operation for activating the web browser 601, and an operation for accessing the web application 501. As a result, user operations can be simplified.

Note that although poster data is described in the present embodiment as an example of print data to be printed by the printing apparatus 102, print data is not limited to poster data. Print data may be not of large size such as a poster, but of relatively small size such as a postcard. The operation of the present embodiment can be applied as long as image data created by a user on the web application 501 can be printed by the printing apparatus 102 using the printing application 602.

### Second Embodiment

The first embodiment describes an example of performing control to deploy layout information to the frontend 502 of the web application 501 through the printing application 602. However, activation of the printing application 602 is in vain for a user who wants to re-edit the layout information on the web application 501. However, for a user who wants to print the layout information, it is cumbersome to activate the web application 501 . Thus, the present embodiment describes an example of processing to properly control the printing application 602 and the web application 501 activated from a file including layout information. Note that the following does not describe points common to those in the first embodiment where appropriate and mainly describes differences.

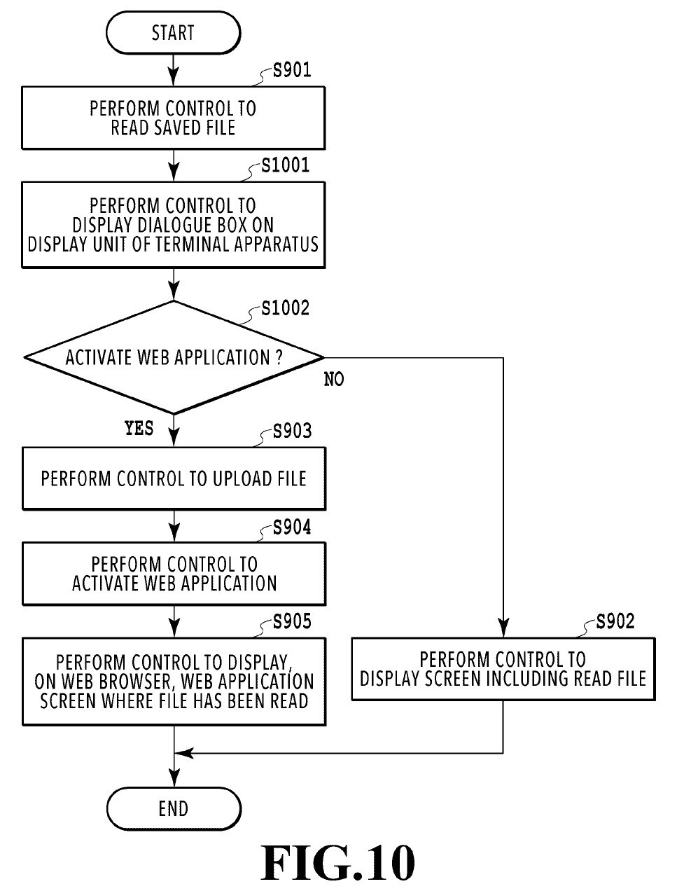

FIG. 10 is a flowchart showing an example flow of processing by the printing application 602 executed in the second embodiment. The flowchart shown in FIG. 10 additionally has processing in S1001 and S1002 between S901 and S902 of the flowchart shown in FIG. 9.

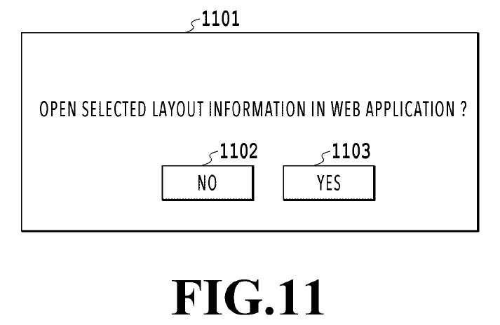

In S1001, the printing application 602 performs control to display a dialogue box on the display unit 204 of the terminal apparatus 101. FIG. 11 is a diagram showing an example dialogue box. The dialogue box is provided with a message 1101, a first button 1102, and a second button 1103. The message 1101 is a message inquiring of a user whether to activate the web application 501. The first button 1102 is a button for receiving an instruction to activate the web application 501. The second button 1103 is a button for receiving an instruction not to activate the web application 501. Once the dialogue box is displayed, the processing proceeds to S1002.

In S1002, the printing application 602 determines whether to activate the web application 501. Once the user presses the first button 1102, the printing application 602 receives an instruction to activate the web application 501. In this case, the printing application 602 determines to activate the web application 501 and proceeds to the processing in S903 after performing control to close the dialogue box. By contrast, once the user presses the second button 1103, the printing application 602 receives an instruction not to activate the web application 501. In this case, the printing application 602 determines not to activate the web application 501 and proceeds to the processing in S902 after performing control to close the dialogue box.

As thus described, in the present embodiment, the printing application 602 as an inquiry unit inquires of the user whether to activate the web application 501. The printing application 602 as the upload control unit does not perform the control for uploading the file to the web server 103 in a case where an instruction not to activate the web application 501 is received. In contrast, printing application 602 as the upload control unit performs the control for uploading the file to the web server 103 in a case where an instruction to activate the web application 501 is received. This enables efficient processing tailored to the user's intention.

Note that in a case where an instruction not to activate the web application 501 is received, the printing application 602 as a display control unit performs control to display a screen including the content of the read file on a screen of the display unit 204. The screen of the display unit 204 is a display screen incorporated in the terminal apparatus 101 and is different from the screen where the web application 501 is displayed. In the present embodiment, a print preview screen including layout information is displayed. A user can check the print preview screen in a case where they wish to print and can check the screen for the web application 501 in a case where they wish to edit the layout information.

In the present embodiment, the printing application 602 may perform control to display the dialogue box shown in FIG. 11 after performing control to display the printing screen shown in FIG. 8. In this case, in the flowchart shown in FIG. 10, the processing in S902 is executed after the processing in S901, and the processing in S1001 is executed after the processing in S902. Also, in S1002, in a case of determining not to activate the web application 501, the printing application 602 ends the flowchart shown in FIG. 10 after performing control to close the dialogue box.

### Third Embodiment

The first embodiment describes an example of control performed to deploy layout information to the frontend 502 of the web application 501 through the printing application 602. However, there are services where not only a native application specialized in print settings, like the printing application 602, but also a native application that can be used to comprehensively perform operations from editing a poster to printing the poster coexists with the web application 501. The present embodiment describes an example of processing performed to activate a native application from a file including layout information and edit a poster image. Note that the following does not describe points common to those in the first embodiment where appropriate and mainly describes differences.

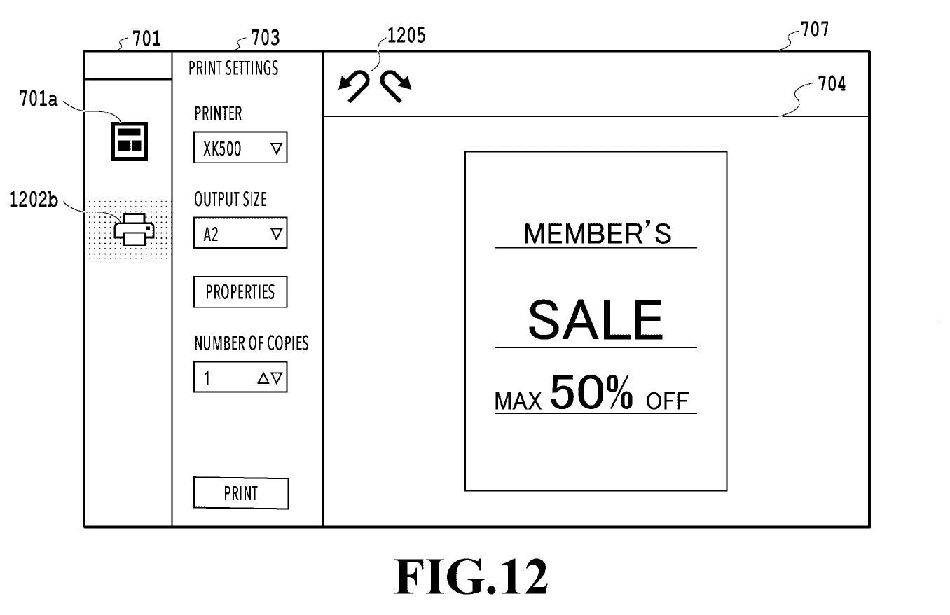

FIG. 12 is a diagram showing an example screen for a native application. The screen for the native application shown in FIG. 12 can be used to comprehensively perform operations from editing a poster to printing the poster.

The screen for the native application shown in FIG. 12 is provided with, as with the image creation screen shown in FIG. 7, a region 701 displaying a menu and a region 703 displaying a list of items associated with the icon selected in the region 701. In the example in FIG. 12, the menu displayed in the region 701 includes a print settings icon 1202b. Also, in the example in FIG. 12, a list of print settings associated with the print settings icon 1202b is displayed. A user can print the image displayed in the edit area 704 as a poster image by pressing the Print button included in the list of print settings displayed in the region 703.

The screen for the native application shown in FIG. 12 is provided with a region 707 displaying a menu of edits that may be performed with respect to the image displayed in the edit area 704. In the example in FIG. 12, a Back button 1205 and a Next button 1206 are displayed in the region 707. The user can change the image to be edited and displayed in the edit area 704 by pressing the Back button 1205 or the Next button 1206.

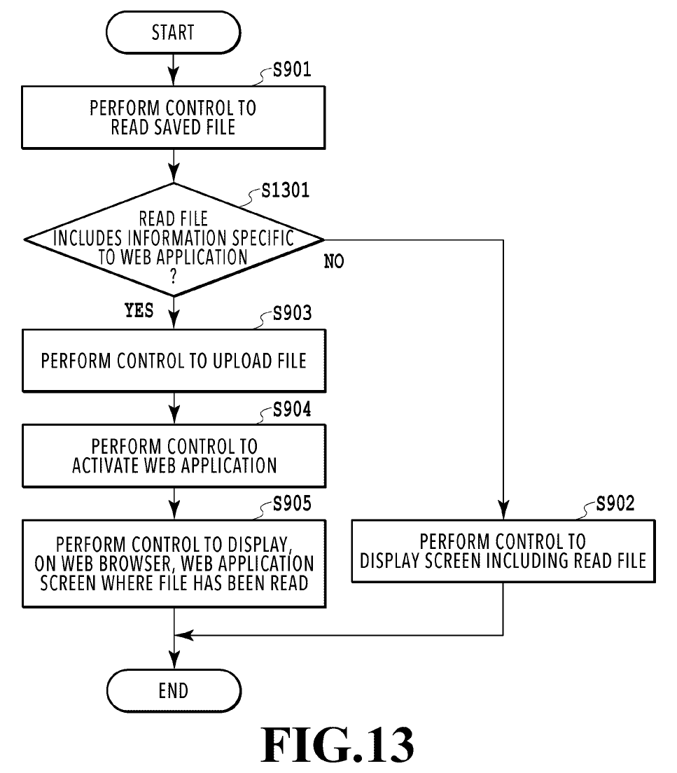

FIG. 13 is a flowchart showing an example flow of processing by the printing application 602 executed in the third embodiment. The flowchart shown in FIG. 13 additionally has processing in S1301 between S901 and S902 in the flowchart shown in FIG. 9.

In S1301, the printing application 602 determines whether the file read in S901 includes information specific to the web application 501. If it is determined that the file includes information specific to the web application 501, the printing application 602 proceeds to the processing in S903. Specifically, the printing application 602 guides the user to the web application 501.

In the present embodiment, information specific to the web application 501 includes information indicating that a text object in the layout information included in the file read in S901 is a web font. Being a native application, the printing application 602 cannot reproduce a web font, and therefore, the processing proceeds to S903.

Also, the information specific to the web application 501 includes information associating the identifier of the user with the identifier of an object related to the layout information included in the file read in S901. In a case where a plurality of users work together to edit a single poster, in order for an edit history to be tracked for each of the users, information associating the identifier of an object and the identifier of the user is recorded in the layout information. Because information associating the identifier of an object and the identifier of the user cannot be analyzed by the printing application 602, the processing proceeds to S903.

Note that the information indicating a web font or the information associating the object identifier and the user identifier is an example of information specific to the web application 501. In a case where the web application 501 has a function absent in the printing application 602, which is a negative application, information related to the function that the web application 501 has is information specific to the web application 501.

In a case where it is determined that the file does not include information specific to the web application 501, the printing application 602 proceeds to processing in S902.

In S902, the printing application 602 performs control to display the content of the file read in S901 on the screen. In the present embodiment, the printing application 602 displays the screen shown in FIG. 12 on the display unit 204 of the terminal apparatus 101 and requests the CPU 202 to display the layout information in the edit area 704 of that screen.

As thus described, in the present embodiment, the printing application 602 as a determination unit determines whether the file includes information specific to the web application 501. The printing application 602 as the upload control unit does not perform the control to upload the file to the web server 103 in a case where the file does not include information specific to the web application 501. By contrast, the printing application 602 performs the control to upload the file to the web server 103 in a case where the file includes information specific to the web application 501. This makes it possible to provide an environment suitable for the user.

In the present embodiment, in a case where it is determined that the file includes information specific to the web application 501, the printing application 602 may inquire of the user whether to activate the web application 501. In this case, the processing in S1001 and the processing in S1002 are added between S1301 and S903 of the flowchart shown in FIG. 13.

### Other embodiments

The present disclosure is not limited to the embodiments described above.

For example, the printing application 602 as the upload control unit may determine whether to perform control to upload the file to the web server 103 based on history information on a history of activation of the web application 501. In this case, the printing application 602 as a storage control unit performs control to store the history information on a history of activation of the web application 501. The history information is stored in a storage device accessible to the CPU 202 at predetermined timing such as, for example, the timing of receiving an instruction to close the printing application 602.

For example, the processing to determine whether to perform the control to upload the file to the web server 103 based on history information is executed in place of the processing in S1301. If the history information indicates that the web application 501 was not activated the last time, the printing application 602 proceeds to the processing in S902. If the history information indicates that the web application 501 was activated the last time, the printing application 602 proceeds to the processing in S903.

For example, the processing to determine whether to perform the control to upload the file to the web server 103 based on history information may be executed at the same time as the processing in S1301. In this case, if the history information indicates that the web application 501 was not activated the last time, it is determined not to perform the control to upload the file to the web server 103 even if the file includes information specific to the web application 501.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

The present disclosure can simplify user operations.

This application claims the benefit of Japanese Patent Application No. 2025-077318, filed May 7, 2025, which is hereby incorporated by reference herein in its entirety.

What is claimed is:

1. A non-transitory computer readable storage medium storing instructions for causing an information processing apparatus to:
perform control to read a file saved in a file format supported by a web application operating in an external device;
perform control to upload, based on information included in the read file, the read file to the external device; and
perform control to display, on a web browser, a screen for the web application where the file uploaded to the external device has been read.

2. The storage medium according to claim 1, wherein
the instructions further cause the information processing apparatus to:
not perform the control to upload the file to the external device in a case where the file does not include the information specific to the web application and
perform the control to upload the file to the external device in a case where the file includes the information specific to the web application.

3. The storage medium according to claim 1, wherein
the instructions further cause the information processing apparatus to determine whether the file includes the information specific to the web application.

4. The storage medium according to claim 3, wherein
the information specific to the web application includes information indicative of a web font.

5. The storage medium according to claim 1, wherein
the instructions further cause the information processing apparatus to make an inquiry to a user whether to activate the web application.

6. The storage medium according to claim 5, wherein
the instructions further cause the information processing apparatus to make the inquiry in a case where the file is read in the file format or in a case where the file includes information specific to the web application.

7. The storage medium according to claim 1, wherein
the instructions further cause the information processing apparatus to perform control to display a screen including content of the read file on a different screen different from a screen on which the screen for the web application is displayed.

8. The storage medium according to claim 7, wherein
the instructions further cause the information processing apparatus to perform the control to display the screen including content of the read file on the different screen in at least one of a case where the file does not include information specific to the web application and a case where an instruction not to activate the web application is received.

9. The storage medium according to claim 1, wherein
the instructions further cause the information processing apparatus to
perform control to store history information indicating a history of activation of the web application and
determine based on the history information whether to perform the control to upload the file to the external device.

10. The storage medium according to claim 9, wherein
the instructions further cause the information processing apparatus to determine not to perform the control to upload the file to the external device in a case where the history information indicates that the web application was not activated the last time, even in a case where the file includes information specific to the web application.

11. The storage medium according to claim 1, wherein
the screen for the web application is a screen where layout information included in the file is editable.

12. An information processing apparatus comprising: one or more processors; and one or more memories storing instructions that, when executed by the one or more processors, cause the information processing apparatus to:
perform control to read a file saved in a file format supported by a web application operating in an external device;
perform control to upload, based on information included in the read file, the read file to the external device; and
perform control to display, on a web browser, a screen for the web application where the file uploaded to the external device has been read.

13. A method for controlling an information processing apparatus, the method comprising:
performing control to read a file saved in a file format supported by a web application operating in an external device;
performing control to upload, based on information included in the read file, the read file to the external device; and
performing control to display, on a web browser, a screen for the web application where the file uploaded to the external device has been read.
